(19) United States
(12) Patent Application Publication
(10) Pub. No.: US 2006/0269329 A1
(43) Pub. Date: Nov. 30, 2006

(54) Image forming apparatus and image forming method

(75) Inventors: Mitsunobu Honda, Osaka-shi (JP); Hidetoshi Miyamoto, Osaka-shi (JP); Yoshiharu Kanematsu, Osaka-shi (JP)

Correspondence Address: HOGAN & HARTSON L.L.P., 1999 AVENUE OF THE STARS, SUITE 1400, LOS ANGELES, CA, 90067, US

(73) Assignee: KYOCERA MITA CORPORATION

(21) Appl. No.: 11/443,970

(22) Filed: May 30, 2006

(30) Foreign Application Priority Data
May 30, 2005 (JP) 2005-157660

(51) Int. Cl. G03G 15/01

(52) U.S. Cl. 399/227; 430/125

(57) ABSTRACT

An image forming apparatus for forming a color image with a plurality of color toners includes: a photosensitive body, a rotary developing device for developing a latent image on the photosensitive body by selectively allowing developing units corresponding to their respective color toners to rotationally move to a developing position opposite the photosensitive body; and a cleaning blade for removing the residual toner on the photosensitive body. At least one color toner in the plurality of color toners is an irregular toner, and other color toners are spherical toners. The volume mean particle size of the irregular toner is not more than the volume mean particle size of the spherical toner. With this construction, high cleaning capability can be attained without impairing the merit of the spherical toner that enables a densely high-fine image to be obtained.

Priority is claimed to Japanese Patent Application No. 2005-157660 filed on May 30, 2005, the disclosure of which is incorporated by reference in its entirety.

### BACKGROUND OF THE INVENTION

1. Field of the Invention

The present invention relates to a color image forming apparatus and an image forming method, which are superior in the capability of cleaning the residual toner on a photosensitive body.

2. Description of Related Art

In an image forming apparatus using toner, attempts to reduce the toner particle size are being pursued to provide high image quality. Generally, grinding process is employed to obtain a small particle size toner. A conventional grinding process, however, suffers from poor yield and high cost of toner manufacturing.

One way to manufacture a small particle size toner is polymerization process. Although the polymerization process calls for a large-scale apparatus, its running cost is low, and it is easy to obtain a small particle size toner and a sharp particle size distribution. Further, it is possible to manufacture a spherical toner having a high sphericity. An image forming apparatus using the spherical toner provides a densely homogeneous image.

Nevertheless, the image forming apparatus using the spherical toner obtainable with the polymerization process or the like has difficulty in cleaning of a photosensitive body. In other words, as a process of cleaning the photosensitive body, there are blade process, brush process, and roller process. However, the blade method has difficulty in cleaning because toner is unsusceptible to aggregate at a toner depositing part of a blade edge, making it difficult to form a blocking layer. It is also difficult to clean the spherical toner having no surface irregularity by allowing it to adhere to the brush of the brush process or the roller of the roller process. Hence, any one of these cleaning processes cannot fully eliminate the spherical toner.

Conventionally, a variety of processes have been employed to improve the capability of cleaning a spherical toner. These conventional processes can be classified into the process of improving the cleaning capability of a toner itself, and the process of improving cleaning capability irrespective of the toner.

As example of the process of improving the capability of cleaning the toner itself, there is a process of improving cleaning capability in which a toner is irregularly shaped by means of, for example, adjustment of polymerizing conditions and stress application after polymerization.

However, the irregularly shaping of a toner impairs the merit inherent in a spherical toner.

Japanese Patent Unexamined Patent Publication No. 2001-188452 describes a process of irregularly shaping a spherical toner by grinding it immediately before a blade.

This process, however, suffers from the increased power costs and the short life of a grinding member because extremely large power is needed for grinding a toner of several μm. Additionally, because the toner is strongly pressed onto a photosensitive body, filming phenomenon is apt to occur, so that image is disturbed.

Japanese Patent Unexamined Patent Publication No. H08-254873 describes a method in which, prior to a spherical toner (color), an irregular toner (black) is fed to a cleaning part. With this method, the black toner that does not so contribute to a densely high-fine image is irregularly shaped, and cleaning is executed by mixing this black toner with spherical color toners. This improves cleaning capability than the case of using only the spherical toner, so that the resulting cleaning capability is almost equal to that obtainable from the irregular toner alone.

This method, however, always cause unnecessary toner consumption because the black toner has to be printed on a non-image part prior to color printing. Publication No. H08-254873 describes that the volume mean particle size of the irregular toner is not less than 7 μm, and that of the spherical toner is not more than 7 μm.

As a process of improving the cleaning capability of a toner other than that described above is to adjust the amounts of charge and an external additive.

The adjustment of the amount of charge, however, fails to fully eliminate the spherical toner. In the process of adjusting the external additive, when the external additive has high aggregating property, the external additive released from the toner is apt to solidify on and adhere to a developing sleeve, a transfer belt, a drum, a charging roller, and a fixing roller. This often causes image noise.

As a process of improving cleaning capability other than that described above is to reduce the adhesion of a toner by applying lubricant to the surface of a drum.

It is however difficult to apply uniformly a friction reducing material such as lubricant for a long period of time. Most of the proposed ones as friction reducing material have wettability. Therefore, under high temperature and high humidity, the resistance value of the drum is lowered to induce an image flow (namely, the surface charge shifts or flows).

Japanese Unexamined Patent Publication No. 2004-117438 describes a process of vibrating the tip of a blade.

With this process, however, the construction of the blade is complicated and high cost. Depending on the toner amount that reaches the blade, flowability, and particle size, the toner may further aggregate, resulting in poor cleaning.

Japanese Unexamined Patent Publication No. 2002-341718 describes a method in which a deterioration of cleaning capability is prevented in combination with a brush and a roller.

With this method, it is however necessary to press both of the brush and the roller into contact with the drum. This increases the size of a cleaning unit, making it impossible to mount the cleaning unit on a process using a small diameter drum.

Japanese Unexamined Patent Publication No. 2002-31997 describes a method of increasing recovery bias in response to a deterioration of the capability of a roller.

This method, however, complicates its control manner and the construction of a power source. Further, because bias has to be changed by the number of printings, the optimum bias potential is not always ensured for the toner amount adhered to the roller.

Another process of improving cleaning capability by means other than the toner is to increase the pressing force of a blade, as described in Japanese Unexamined Patent Publication No. 2003-084637.

However, the increased pressing force of the blade increases the motor torque necessary for rotating a drum. Additionally, the blade will wear early to shorten its life.

### SUMMARY OF THE INVENTION

An advantage of the present invention is to provide an image forming apparatus and a method for forming an image, which have high cleaning capability without impairing the merit of a spherical toner that permits a densely high-fine image.

The present inventors have made tremendous research effort to solve the above-mentioned problems, and have given attention to the fact that the cleaning capability of an irregular toner is higher than that of a spherical toner. They have completed the present invention based on the following new finding that a combination of an irregular toner and a spherical toner, each having a specific volume mean particle size, achieves an image forming apparatus that is low price and compact, and exhibits stable cleaning capability, as well as a method for forming an image.

Specifically, the image forming apparatus of the present invention, which forms a color image with a plurality of color toners, includes: a photosensitive body, a rotary developing device for developing a latent image on the photosensitive body by selectively allowing developing units corresponding to their respective color toners to rotationally move to a developing position opposite the photosensitive body; and a cleaning blade for removing a residual toner on the photosensitive body. At least one color toner in the plurality of color toners is an irregular toner, and other color toners are spherical toners. The volume mean particle size of the irregular toner is not more than the volume mean particle size of the spherical toners.

The method for forming an image of the present invention includes: the step of forming a color image with a plurality of color toners by developing a latent image on a photosensitive body by selectively allowing developing units corresponding to their respective color toners to rotationally move to a developing position opposite the photosensitive body; and a cleaning step of removing a residual toner on the photosensitive body by a cleaning blade. At least one color toner in the plurality of color toners is an irregular toner, and other color toners are spherical toners. The volume mean particle size of the irregular toner is not more than the volume mean particle size of the spherical toners.

In accordance with the present invention, the use of the spherical toners produces the effect of providing a densely high-fine image. In addition, the present invention employs the combination of the irregular toner and the spherical toners, wherein the volume mean particle size of the irregular toner is not more than that of the spherical toners, so that the irregular toner having a small particle size will mainly aggregate and form a blocking layer at a toner depositing part in a blade edge of the cleaning blade. This eliminates the escape of the toners, and permits high cleaning capability even when a spherical toner having a poor cleaning capability is used.

Other objects and advantages of the present invention will become more apparent from the following detailed description of the present invention when taken in conjunction with the accompanying drawings.

### BRIEF DESCRIPTION OF THE DRAWINGS

FIG. 1 is a schematic explanatory diagram illustrating an image forming apparatus according to one preferred embodiment of the present invention;

FIG. 2 is a schematic explanatory diagram illustrating the behavior of toners in the vicinity of a blade edge; and

FIGS. 3 (a) and 3 (b) are schematic explanatory diagrams illustrating the toner recovery and discharge operations of a roller.

### DETAILED DESCRIPTION OF PREFERRED EMBODIMENTS

<Image Forming Apparatus and Method>

An image forming apparatus of the present invention is directed to one that forms a color image with a plurality of color toners. The image forming apparatus includes: a photosensitive body; a rotary developing device of so-called one-drum four-cycle system, which develops a latent image on the photosensitive body by selectively allowing developing units corresponding to their respective color toners to rotationally move to a developing position opposite the photosensitive body; and a cleaning blade for removing a residual toner on the photosensitive body.

At least one color toner in the plurality of color toners is an irregular toner, and other color toners are spherical toners. Specifically, it is preferable that, for example, a black toner is an irregular toner, and the other colors (for example, yellow, magenta, and cyan) are spherical toners. This provides a densely high-fine image. The reason for this is that the black toner not so contributing to the densely high-fine image is used as the irregular toner, and the color toners contributing to this image are used as the spherical toners. Without limiting to this, two or more toners may be irregular toners.

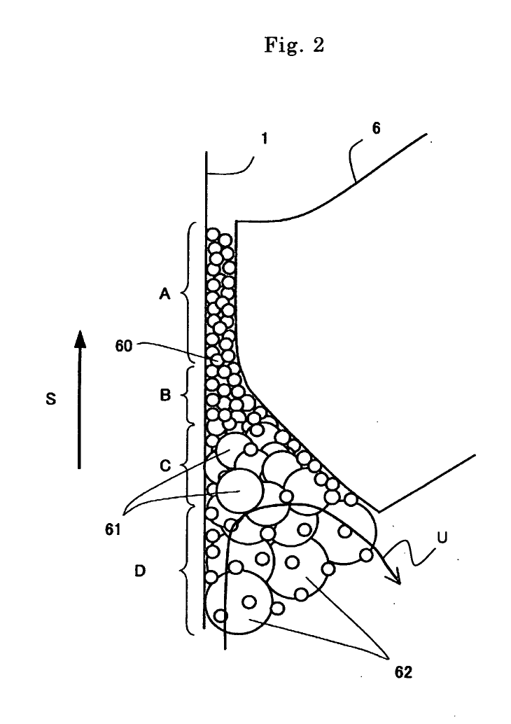

Here, the volume mean particle size of the irregular toner is not more than the volume mean particle size of the spherical toners. This is because, when the irregular toner has a small particle size, as will be described later, it will easily enter into the vicinity of a nip entrance B in a cleaning step, as shown in FIG. 2, and the strength of a depositing layer owing to the irregular shape can be used to improve cleaning capability.

Preferably, the volume mean particle size of the irregular toner satisfies the following equation (I). This ensures improvement of cleaning capability.
A<0.9×B (I)
where A is the volume mean particle size of an irregular toner; and B is the volume mean particle size of a spherical toner.

Preferably, the volume mean particle size of the irregular toner is 6 μm to 14 μm, and the volume mean particle size of the spherical toners is 5 μm to 12 μm. That is, within this range, the volume mean particle size of the irregular toner may be not more than that of the spherical toner. The above-mentioned volume mean particle size is the values obtained from measurements on a “Multisizer II type” of Coulter Corporation, as will be described later.

Preferably, the mean roundness of the spherical toners is not less than 0.97. The use of the spherical toners enables a densely high-fine image to be obtained. A higher mean roundness means a higher sphericity of the toner. Accordingly, in the present invention, it is preferable that the spherical toners are toners having a roundness of not less than 0.97, and the irregular toner is a toner having a roundness of less than 0.97, preferably less than 0.97 and not less than 0.89. The above-mentioned mean roundness is the value obtained from measurements on a flow type particle image analyzer (“FPIA-2100” manufactured by Sysmex Corporation).

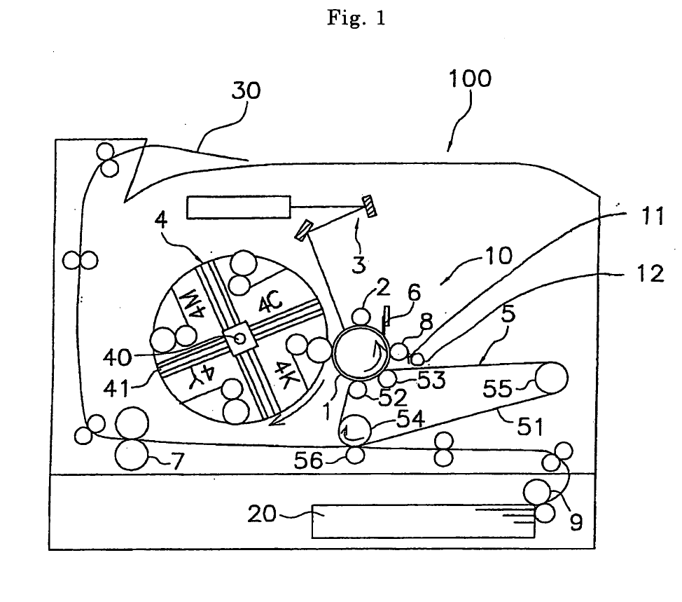

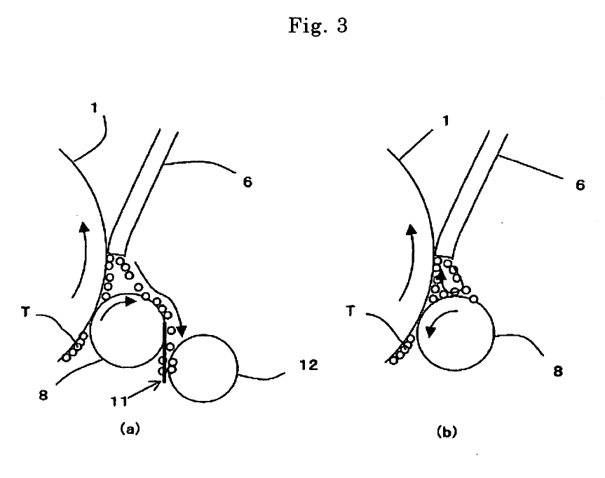

The image forming apparatus and the method for forming an image according to one preferred embodiment of the present invention as described above will be described in detail with reference to the accompanying drawings. FIG. 1 is a schematic explanatory diagram illustrating an image forming apparatus according to the preferred embodiment. FIG. 2 is a schematic explanatory diagram illustrating the behavior of toners in the vicinity of a blade edge. FIGS. 3 (a) and 3 (b) are schematic explanatory diagrams illustrating the toner recovery and discharge operations of a roller.

Referring to FIG. 1, this image forming apparatus is a color image forming apparatus 100 of one-drum four-cycle system. That is, an image forming part 10 is disposed substantially centrally of the color image forming apparatus 100. The image forming part 10 has a drum-shaped photosensitive body (namely a photosensitive body drum) 1. A charging device 2, an exposing device 3, a developing device 4, a transferring device 5, a roller 8, and a cleaning blade 6 are disposed in this order around the photosensitive body drum 1 in the direction of its movement. A fixing device 7 is disposed on the downstream side in the direction of paper conveyance of the photosensitive body drum 1. A paper feeding part 20 is disposed at a lower part of the image forming apparatus 100. A paper feeding roller 9 is disposed on the downstream side in the direction of paper feed of the paper feeding part 20.

The photosensitive body drum 1 is one, on the surface of which formed is an electrostatic latent image. The preferred embodiment employs an amorphous silicon photosensitive body, which is constructed by laminating in sequence, on a conductive substrate, a carrier injection blocking layer that is for example composed of Si, H, B, and O, a carrier excitation and transporting layer (a photoconductive layer) that is for example composed of Si and H, and a surface protecting layer that is for example composed of SiC and H.

The charging device 2, which is disposed above the photosensitive body drum 1, charges uniformly the photosensitive body drum 1. The exposing device 3 forms an electrostatic latent image on the photosensitive body drum 1, based on an original image read from an image data inputting part (not shown).

The developing device 4 forms a toner image by supplying toners onto the surface of the photosensitive body drum 1, on which the electrostatic latent image is formed. Here, the developing device 4 has a rotary rack 41 and a plurality of developing units 4Y, 4M, 4C, and 4K. The rotary rack 41, while rotating around a rotation shaft 40 by rotating means (not shown), allows the developing units 4Y, 4M, 4C, and 4K to perform development while moving in sequence to a developing position opposite the photosensitive body drum 1.

The plurality of developing units, namely the yellow developing unit 4Y, the magenta developing unit 4M, the cyan developing unit 4C, and the black developing unit 4K, are arranged and held circumferentially of the rotary rack 41 in the order of 4Y, 4M, 4C, and 4K, which are spaced approximately 90° from each other. In the preferred embodiment, the black toner contained in the black developing unit 4K is the irregular toner (less than 0.97 in mean roundness), and the color toners other than the black toner, namely a yellow toner, a magenta toner, and a cyan toner which are contained in the yellow developing unit 4Y, the magenta developing unit 4M, and the cyan developing unit 4C, respectively, are the spherical toners (not less than 0.97 in mean roundness).

The transferring device 5 transfers a toner image of the photosensitive body drum 1 onto paper, and has an intermediate transferring belt 51, primary transferring rollers 52 and 53, and a driving roller 55, a secondary transferring opposite roller 54, and a secondary transferring roller 56. The intermediate transferring belt 51 is wound in endless fashion around the primary transferring rollers 52 and 53, the driving roller 55, and the secondary transferring opposite roller 54, and is driven by the driving roller 55. The intermediate transferring belt 51 also functions as an object of transfer, onto which a toner image formed on the photosensitive body drum 1 is transferred and held temporarily.

The secondary transferring roller 56 is disposed at a position opposite the secondary transferring opposite roller 54 in the outer peripheral surface of the intermediate transferring belt 51, and functions to perform secondary transferring of the toner image onto a transfer material.

The cleaning blade 6 cleans deposits such as the residual toner on the photosensitive body drum 1. Preferably, the cleaning blade 6 is made of rubber having a hardness of 60 to 80 degrees (for example, urethane rubber), and the cleaning blade 6 presses on the photosensitive body drum 1 under a linear load of 10 to 40 N/m.

The roller 8 is pressed into contact with the surface of the photosensitive body drum 1, and functions as a buffer for recovering and discharging the toners. Preferably, the roller 8 is constructed by covering the peripheral surface of a metallic shaft with a rubber layer having a hardness of 40 to 70 degrees (for example, an expanded rubber layer), and it is urged against the photosensitive body drum 1 by springs (not shown) disposed one at each side of an bearing under 500 to 2000 gf (i.e., 250 to 1000 gf per spring).

Referring to FIG. 3 (b) to be described later, it is preferable that the roller 8 makes rotations in the reverse direction (the counter direction), namely counter rotations with respect to the photosensitive body drum 1 in the cleaning step. This enables the toners successively fed to a cleaner part to stay in the vicinity of the blade edge. In the roller 8, when it performs no cleaning operation, the drive transmission can be turned off by a driving clutch (not shown).

Referring to FIG. 3 (a), it is preferable that, after the cleaning step, the roller 8 makes rotations in the same direction (with-direction), namely forward rotations with respect to the photosensitive body drum 1. By so constructing the roller 8, as will be described later, the irregular toner and the spherical toners can be mixed in the cleaning step, so that the high cleaning capability owing to the irregular toner can be exhibited.

In the case where the toner adsorption and discharge with respect to the roller 8 is controlled by the polarity of bias applied to the roller 8, the roller 8 may make the forward rotations in the with-direction with respect to the photosensitive body drum 1. The drive transmitting clutch is provided for preventing the photosensitive body drum 1 from being more polished than necessary, however, when the drum 1 has a sufficient laminate thickness, it is unnecessary to turn off the drive.

In the rotational speed of the roller 8, it is preferable that the surface speed at its contacting part is set to be higher than the rotational speed of the photosensitive body drum 1, and it is normally 1 to 1.5 times.

The fixing device 7 fixes the transferred toner image onto paper. In FIG. 1, the reference numeral 11 designates a scraper for scraping the toner adhered to the roller 8, and the reference numeral 12 designates a recovery screw for recovering the toner adhered to the roller 8, or the toner scraped by the blade 6 and dropped on the roller 8. The recovery screw discharges the recovered residual toner into a waste toner box (not shown).

The image formation with the image forming apparatus 100 as described above will next be described. First, after the charging means 2 performs charging to the photosensitive body drum 1, the rotary rack 41 rotationally moves around the rotation shaft 40 disposed centrally thereof.

The rotational movement of the rotary rack 41 is stopped, for example, when the developing unit 4K corresponding to black rotationally moves to a developing position opposite the photosensitive body drum 1. In this state, the exposure corresponding to the black is performed by the exposing means 3, so that an electrostatic latent image corresponding to the black is formed on the surface of the photosensitive body drum 1. This electrostatic latent image is then brought into a toner image by the developing unit 4K. Subsequently, this toner image is transferred onto the transferring belt 51 by a transferring bias applied to the primary transferring rollers 52 and 53 (a primary transfer step). Thus, the black toner image is formed on the transferred belt 51.

Next, like the developing unit 4K, for example, the developing unit 4C corresponding to cyan rotationally moves to a developing position opposite the photosensitive body drum 1, and then a cyan toner image is formed on the transferring belt 51, in the same manner as the developing unit 4K. Such an operation is similarly performed with respect to other colors, namely magenta and yellow, so that a full-color toner image is formed on the transferring belt 51. The full-color toner image is a densely high-fine image because the black toner is the irregular toner, and the yellow toner, the magenta toner, and the cyan toner are the spherical toners, as above described.

Although in the above primary transfer step, the secondary transferring roller 56 is apart from the transferring belt 51, when the full-color toner image is formed on the transferring belt 51, the secondary transferring roller 56 abuts against the transferring belt 51. At the same timing as the abutment, a transfer material is conveyed from the paper feeding part 20 to a transfer position by the paper feeding roller 9, and the like. The full-color toner image formed on the transferring belt 51 is then transferred on the transfer material by the secondary transfer bias applied onto the secondary transferring roller 56. The full-color toner image transferred on the transfer material is then fixed on the transfer material by heating and pressing in the fixing means 7. Thereafter, the transfer material is discharged into a paper discharging part 30. A densely high-fine image is formed on the transfer material.

The residual toner remaining in the photosensitive body drum 1 can be cleaned with the cleaning blade 6, and then discarded in a waste toner container (not shown) (the cleaning step). In the cleaning step, the above-mentioned toner is formed of the irregular toner and the spherical toners, in which the volume mean particle size of the irregular toner is equal to or smaller than that of the spherical toners. Therefore, as will be described later, the irregular toner having a small particle size will mainly aggregate and form a blocking layer at the toner depositing part in the blade edge of the cleaning blade 6. This prevents the escape of the toners, allowing the high cleaning capability to be exhibited.

It is also possible to clean the residual toner on the transferring belt 51 by pressing a cleaning device (not shown) of the transferring belt 51 into contact with the transferring belt 51 after the secondary transfer. The residual toner so cleaned is then discarded in the waste toner container (not shown). The cleaning device is constructed so as to leave from the transferring belt 51 after cleaning the entire length of the transferring belt 51.

It should be noted that the rotary rack 41 does not rotate when forming a monochrome image, and development may be performed with only the developing unit 4K opposed to the photosensitive body drum 1. Other operations for image formation are the same as the case of forming a color image.

The following is the behavior of the toners in the vicinity of the edge of the cleaning blade 6. As shown in FIG. 2, firstly, a not-transferred toner (namely a residual toner) adherers to the photosensitive body drum 1, and moves from below with respect to the direction of movement of the drum 1 (the direction indicated by the arrow S in FIG. 2). This residual toner contains a toner 61 that is an irregular toner, and a toner 62 that is a spherical toner, and further contains a later-described external additive 60, which has been subjected to adhesion process to the toner surface (i.e., external addition process).

When this residual toner collides with the blade 6 and is then agitated, the external additive 60 releases from the toner surface, and deposits in a blade nip A and in the vicinity of the nip entrance B. Thus, the external additive 60 exhibits, within the nip A, the function as lubricant of the drum 1 and the blade 6, and its deposition at the nip entrance B prevents the toners 61 and 62 from entering into the nip A.

On the other hand, when the external additive 60 is not released from the toners 61 and 62, the drum 1 and the blade 6 will contact with each other. This is unfavorable because there is the danger of a so-called blade peeling. There is also the danger that the toners 61 and 62 enter into the vicinity of the nip entrance B, failing to eject therefrom, and hence they enter into the nip A, thereby inducing image noise. In other words, the toners 61 and 62 might fail to move in U-turn fashion, as indicated by the arrow U.

In the vicinity of the blade edge, the toners 61 and 62, and the external additive 60 are deposited at a triangle region formed by the drum 1 and the blade 6. In this depositing layer, small particles gather near the nip entrance B. That is, smaller particles are more liable to enter through the space between large particles, so that a particle size distribution can be formed naturally. Hereat, the volume mean particle size of the irregular toner is not more than that of the spherical toner, as described above. Consequently, a deposition area C of the toner 61 and a deposition area D of the toner 62 are formed behind the nip entrance B where the external additive 60 deposits.

The cleaning capability of the toners 61 and 62 depends on the strength of the external additive depositing layer and the toner depositing layer formed at the blade edge. In other words, it depends on whether, when the toners collide one after another with these depositing layers, they can block the toners without being broken nor pushed.

Specifically, the irregular toner is capable of forming a stronger toner depositing layer than the spherical toner. When a first toner processed with an external additive having high aggregating property is compared with a second toner not process with this external additive, the first toner provides a stronger depositing layer. When the toners having the same shape are compared, the toner having a larger particle size provides a stronger depositing layer. The strength of a toner depositing layer depends on various toner characteristics and factors, mainly on its shape.

The present invention employs the irregular toner having a small particle size, whereby easy entrance into the nip entrance B owing to the small particle size, and the strong depositing layer owing to the irregular shape can be utilized to improve cleaning capability. As a result, there is no need to perform the deforming process for improving cleaning capability as in the case of normal spherical toners. This permits a color process maximizing such a merit of the spherical toners that enables a densely high-fine image to be obtained, without deforming the spherical toners.

The toner recovery and discharge operations of the roller 8 will next be described with reference to FIGS. 3 (a) and 3 (b). In these drawings, the toners 61 and 62 are collectively designated as a toner T. As shown in FIG. 3 (a), in the case where the surface of the roller 8 is rotating in the same direction as the drum 1 (in the with-direction), namely it is making the forward rotation, the toner T adhered to the roller 8, or the toner T scraped by the blade 6 and dropped on the roller 8 is conveyed by gravity to the waste toner box by the recovery screw 12. In order to achieve more reliable toner separation from the roller 8, the scraper 11 may be pressed into contact with the roller 8. Instead of the roller 8, a brush roll with fine fibers implanted therein may be used, and it may be further provided with a contacting member (a flicker) for reliable toner separation from the brush roll.

On the other hand, as shown in FIG. 3 (b), in the case where the roller 8 is rotating in the reverse direction (in the counter direction), namely it is making the counter rotation, the toner T adhered to the roller 8 from the drum 1, and the toner T scraped by the blade 6 and dropped on the roller 8 will adhere again to the drum 1, and then be supplied to the blade 6. Thus, when the roller 8 makes the counter rotation, the toner T remaining on the drum 1 is not discharged to the waste toner box, so that it circulates between the blade 6 and the roller 8.

It is therefore preferable to construct so that the roller 8 makes the counter rotation with respect to the drum 1 in the cleaning step, and the roller 8 makes the forward rotation with respect to the drum 1 after the cleaning step. Although in the one-drum four-cycle process, the respective color toners T successively reach the cleaner part, the counter rotation of the roller 8 enables these toners T to be mixed and supplied to the edge of the blade 6, allowing the irregular toner to exhibit its high cleaning capability. On the contrary, in the case of the with-rotation, the toners T successively move to the recovery screw 12, making it impossible to mix the toners T.

In the preferred embodiment, the counter rotation continues during the cleaning operation, and after the passage of the surface portion of the drum 1, which corresponds to the rear end of an image, the drive transmission to the roller 8 is turned off to have the roller 8 make the with-rotation.

<Manufacturing Method of Toner>

The following is a method for manufacturing an irregular toner and a spherical toner, which are applicable to the present invention.

A suitable irregular toner of the present invention is one obtained by grinding classification method. To attain a toner having a high sphericity (not less than 0.97 in mean roundness), a suitable spherical toner is one obtained by polymerization method, such as suspension polymerization method or emulsion polymerization condensation method. Alternatively, there may be used a spherical toner obtained by melt granulation method or spray granulation method, instead of polymerization method.

In the grinding classification method for obtaining an irregular toner, firstly, a toner composition is prepared by adding a charge control agent, wax, and the like, as required, to binding resin, coloring agent and magnetic power. Subsequently, the toner composition is premixed with a Henshel mixer or a V-type mixer, and then melt-kneaded with a melt kneader such as a biaxial extruder. After cooling the melt-kneaded matter, it is subjected to rough grinding and fine grinding, and then classification as required, thereby obtaining an irregular toner having a predetermined particle size distribution.

In the suspension polymerization method for obtaining a spherical toner, firstly, a monomer composition is obtained by allowing coloring agent, wax, charge control agent, and cross linking agent to disperse in polymer monomer. The monomer composition so obtained is then agitated in a water medium (for example, water, or a mixed solvent of water and water-miscible solvent) so as to have a suitable particle size. To this composition, polymerization initiator is added and heated, so that the polymer monomer is polymerized to obtain spherical toner particles.

In the emulsion polymerization coagulation method, firstly, a resin dispersed solution is prepared by emulsion polymerization. Separately, an additive dispersed solution is prepared by allowing coloring agent, wax and charge control agent to disperse in solvent. These solutions are then mixed to form aggregated particles corresponding to toner particles. The aggregated particles are allowed to melt by heating, to obtain spherical toner particles.

No particular limitations are imposed on the above-mentioned binding resin or polymer resin (namely, the polymerized matter of polymer monomer in the suspension polymerization method, or the aggregated particles in the emulsion polymerization coagulation method). For example, there are thermoplastic resins such as styrene-acryl resin, polyester resin, polyacrylic resin, polyethylene resin, polypropylene resin, vinyl chloride resin, polyamide resin, polyurethane resin, polyvinyl alcohol resin, vinyl ether resin, N-vinyl resin, and styrene-butadiene resin. As required, other resin may be combined with these resins, alternatively, the above-mentioned resins may be used in combination.

No particular limitations are imposed on the above-mentioned coloring agent. Examples of black coloring agent are carbon black such as acetylene black, lamp black, and aniline black. Examples of magenta coloring agent are C. I. pigment red 81, C. I. pigment red 122, C. I. pigment red 57, C. I. pigment red 238, C. I. pigment red 49, C. I. solvent red 49, C. I. solvent red 19, C. I. solvent red 52, C. I. basic red 10, and C. I. disperse red 15, which are presented in Color Index. Examples of cyan coloring agent are C. I. pigment blue 15, C. I. pigment 15-1, C. I. pigment 15-3, C. I. pigment blue 16, C. I. solvent blue 55, C. I. solvent blue 70, C. I. direct blue 86, and C. I. direct blue 25, which are presented in Color Index. Examples of yellow coloring agent are nitro pigments such as naphthol yellow S, azo pigments such as Hansa yellow 5G, Hansa yellow 3G, Hansa yellow G, benzidine yellow G, and vulcan fast yellow 5G; inorganic pigments such as yellow iron oxide, and loess; C. I. pigment yellow 180, C. I. pigment yellow 74, C. I. solvent yellow 2, C. I. solvent yellow 6, C. I. solvent yellow 14, C. I. solvent yellow 15, C. I. solvent yellow 16, C. I. solvent yellow 19, and C. I. solvent yellow 21, which are presented in Color Index. These coloring agents may be used individually or in combination.

These coloring agents are normally blended in an amount of 2 to 20 parts by weight, preferably 3 to 10 parts by weight, to the total amount of the binding resin or the polymer resin of the toner.

The above-mentioned charge control agent is added in order to considerably improve a charging level and charge rise characteristic (the index whether it can charge to a certain charging level in a short time) so as to attain characteristics excellent in durability and stability. Specifically, a positively charging charge control agent is added when the toner is positively electrified for development, and a negatively charging charge control agent is added when the toner is negatively electrified for development.

No particular limitations are imposed on the above charge control agent. Examples of the positively charging charge control agent are azine compound such as pyridazine; direct dye composed of azine compound such as azine fast red FC; nigrosine compounds such as nigrosine, nigrosine salt, and nigrosine derivative; acid dye composed of nigrosine compound such as nigrosine BK; metallic salts of naphthenic acid or higher fatty acid; alkoxyl amine; alkyl amide; and quaternary ammonium salt such as benzylmethylhexyldecyl ammonium. These may be used individually or in combination.

Alternatively, quaternary ammonium salt, carboxylic acid salt, resin having carboxyl group as a functional group, or oligomer can also be used as a positively charging charge control agent. More specifically, one type or two or more types of styrene resin having quaternary ammonium salt, styrene resin having carboxyl acid salt, and polystyrene resin having a carboxyl group can be used.

As a charge control agent exhibiting negatively charging property, organic metallic complex or chelate compound is effective. For example, there are aluminium acetylacetonate, ferrous acetylacetonate, and 3,5-di-tert-butyl chrome salicylate. In particular, acetylacetone metallic complex, and salicylic acid metallic complex or salt are preferred. Among these, salicylic acid metallic complex and salicylic acid metallic salt are preferred.

The above-mentioned charge control agents having positively charging property or negatively charging property is contained in an amount of 1.5 to 15 mass parts, preferably 1.5 to 8.0 mass parts, more preferably 1.5 to 7.0 mass parts, to the total amount of binding resin. When the amount of addition of charge control agent is lower than the above-mentioned range, there is a tendency to make it difficult to stably charge the toner so as to have a predetermined polarity. When this toner is used to develop an electrostatic latent image in order to form an image, its image density may be lowered, and the durability of the image density may be lowered. Further, poor dispersion of the charge control agent is apt to occur, which may cause so-called fog, or the photosensitive body may be contaminated remarkably. On the other hand, when charge control agent is used in an amount exceeding the above-mentioned range, problems may arise with resistance to environment, particularly, poor charge and poor image under high temperature and high humidity, so that defects such as photosensitive body contamination are apt to occur.

No particular limitations are imposed on the above-mentioned wax. It is however preferable to use polyethylene wax, polypropylene wax, Teflon (registered trademark) wax, Fischer-Tropsch wax, paraffin wax, ester wax, montan wax, or rice wax. These waxes may be used in combination. This enables more efficient prevention of offset property and image smearing (dirt around an image when it is scratched).

Preferably, the above wax is blended in an amount of 1 to 10 mass parts to the total amount of binding resin. When the amount of addition of wax is less than 1 mass part, there is a tendency to fail to efficiently prevent the offset property and the image smearing. On the other hand, over 10 mass parts, there may induce fusion between the toners, thus lowering preservation stability.

It is preferable to externally add an external additive to the above-mentioned irregular toner and spherical toner. This permits exhibition of the above-mentioned effect, that is, the function as lubricant for the drum 1 and the blade 6 in the interior of the nip A. Further, the deposition at the nip entrance B prevents the toners 61 and 62 from entering into the nip A. It is also possible to adjust the charge control property and the flowability of the toners. Examples of the external additive are inorganic fine powders such as silica, titanium oxide, aluminium oxide, zinc oxide, magnesium oxide, and calcium carbonate; organic fine powder such as polymethylmethacrylate; and the fine powder of fatty acid metallic salt such as zinc stearate. Among these, the inorganic fine powder, particularly silica is preferred. This enhances the above-mentioned effect. Especially, the combination of titanium oxide and silica is more preferable to enhance the aggregating property of the spherical toners.

When silica is added as the external additive, it is preferable that the volume mean particle size of the irregular toner satisfies the above-mentioned equation (I), namely it is not more than 0.9 times, preferably 0.7 to 0.9 times the volume mean particle size of the spherical toner. Especially, when the external additive is the combination of silica and titanium oxide, it is preferable that the volume mean particle size of the irregular toner is equal to or less than the volume mean particle size of the spherical toner. Specifically, the former is 0.7 to 1.0 time the latter.

Preferably, the amount of addition of the external additive is 0.05 to 4.0 parts by weight to 100 parts by weight of the toner particles. The blending of the external additive and the toner particles can be performed by using, for example, a Henshel mixer or a V-type mixer, Tarbular mixer, Hybritizer, or the like.

Examples of the present invention will be described below. It is understood, however, that the examples are for the purpose of illustration and the invention is not to be regarded as limited to any of the specific materials or condition therein.

### EXAMPLES

### Reference Example

### Toner Manufacturing

The irregular toner and the spherical toner according to the present invention were manufactured in the following procedure.

[Irregular Toner]

The irregular toner was obtained by grinding classification method. Specifically, a kneaded matter was firstly obtained by mixing (i) bisphenol A type polyester resin as binding resin (manufactured by Mitsui Chemicals, Inc., 15,000 in weight-average molecular weight (Mw), 4,300 in number-average molecular weight (Mn), and 3.5 in Mw/Mn); (ii) 5 parts by weight of carbon black and (iii) 2 parts by weight of nigrosine N21 (manufactured by Orient Chemical Industries, Ltd.) as charge control agent (CCA), to 100 parts by weight of the binding resin; and (iv) 5 parts by weight of carnauba wax as wax, followed by kneading with a two-roll kneader at 100° C. for 30 minutes.

The kneaded matter so obtained was then roughly ground, followed by fine grinding with a jet stream grinder of collision plate type. At this time, the air pressure of the fine grinding was changed and classified with a turbo classifier, so that powder A having a volume mean particle size of 6.1 μm, powder B having a volume mean particle size of 6.8 μm, and powder C having a volume mean particle size of 7.6 μm were obtained respectively.

Next, an irregular toner A was obtained by adding 1.5 parts by weight of silica (“RA200HS,” the product name of Nippon Aerosil Co., Ltd.) to 100 parts by weight of the above powder A, followed by mixing with a Henshel mixer. In order that the powder B and the powder C have the same amount of silica adhered to the powder surface per unit area, as the above-mentioned toner A, 1.35 parts by weight of silica was added to the powder B to obtain an irregular toner B, and 1.20 parts by weight of silica was added to the powder C to obtain an irregular toner C. The mean roundness of the irregular toner A and that of the irregular toner B were 0.91, and that of the irregular toner C was 0.92.

[Spherical Toner Containing External Additive (Only Silica)]

A spherical toner was obtained by suspension polymerization method. Specifically, a mixed solution was firstly obtained by mixing 80 parts by weight of styrene, 20 parts by weight of 2-ethylene hexyl methacrylate, 5 parts by weight of coloring agent, 3 parts by weight of low molecular weight polypropylene, 2 parts by weight of charge control agent (quaternary ammonium salt), and 1 part by weight of divinylbenzene (cross linking agent).

To the mixed solution so obtained, 2 parts by weight of 2,2-azobis (2,4-dimethyl valeronitril) as polymerization initiator was added. This was then added to 400 parts by weight of purified water. Further, as suspension fixing agent, 5 parts by weight of tertiary calcium phosphate and 0.1 parts by weight of dodecyl benzenesulfonic acid sodium were added and agitated with a TK homomixer (manufactured by Tokushu Kika Kogyo) for 20 minutes under 7000 rpm in number of revolution.

After the agitation, the above mixed solution was subjected to polymerization reaction for 10 hours under nitrogen atmosphere at 70° C. and 100 rpm, resulting in powder having a volume mean particle size of 6.3 μm. To 100 parts by weight of this powder, 1.5 parts by weight of silica (“RA200HS”, the product name of Nippon Aerosil Co., Ltd.) was added and mixed by a Henshel mixer, resulting in a spherical toner F having a volume mean particle size of 6.3 μm. Since C.I. pigment blue 15 was used as the above-mentioned coloring agent, the spherical toner F was cyan toner. The mean roundness of the spherical toner F was 0.97.

The number of revolution of the TK homomixer was then changed, and silica was added as follows, so that the amount of silica adhered to the powder surface per unit area was the same as that of the toner F. That is, (i) 1.3 parts by weight of silica was added to a spherical toner D, (ii) 1.4 parts by weight of silica to a spherical toner E; (iii) 1.6 parts by weight of silica to a spherical toner G; (iv) 1.7 parts by weight of silica to a spherical toner H; (v) 1.8 parts by weight of silica to a spherical toner I; (vi) 1.9 parts by weight of silica to a spherical toner J; and (vii) 2.0 parts by weight of silica to a spherical toner K. As a result, there were formed the spherical toner D having a volume mean particle size of 5.5 μm, the spherical toner E having a volume mean particle size of 5.9 μm, the spherical toner F having a volume mean particle size of 6.3 μm, the spherical toner G having a volume mean particle size of 6.7 μm, the spherical toner H having a volume mean particle size of 7.2 μm, the spherical toner I having a volume mean particle size of 7.6 μm, the spherical toner J having a volume mean particle size of 8.0 μm, and the spherical toner K having a volume mean particle size of 8.5 μm.

The spherical toners D, E, and G to K were composed of a yellow toner, a magenta toner, and a cyan toner, which contain their respective corresponding charge control agent and pigment as follows:

Charge Control Agent: Bontron N-07 (having positively charging property)

Coloring Agent (Pigment):
Yellow pigment: C. I. pigment yellow 74, 180, etc.
Magenta pigment: C. I. pigment red 57, 122, 238, etc.
Cyan pigment: C. I. pigment blue 15:1, 15:3, etc.

Yellow Toner: the spherical toners J, K

Magenta Toner: the spherical toners G, H, I

Cyan Toner: the spherical toners D, E

The mean roundness of each of the spherical toners D, and G to K was 0.97, and that of the spherical toner E was 0.98.

[Spherical Toner Containing External Additive (Silica and Titanium Oxide)]

Except that the external additive was changed from 1.5 parts by weight of silica to 1.0 part by weight of silica and 0.5 parts by weight of titanium oxide (the product name “EC100T1,” manufactured by Titan Kogyo), the same material and the same method as the spherical toner F were employed to form a spherical toner F′ having a volume mean particle size of 6.3 μm.

Like the spherical toner F′, except that the external additive was changed from 1.5 parts by weight of silica to 1.0 part by weight of silica and 0.5 parts by weight of titanium oxide, there were employed the same material and the same method as the spherical toners D, E, and G to K, respectively, and silica was added as follows, so that the amount of silica adhered to the powder surface per unit area was the same as that of the toners D, E, and G to K, respectively. That is, (i) 0.87 parts by weight of silica and 0.4 parts by weight of titanium oxide were added to the spherical toner D′, (ii) 0.94 parts by weight of silica and 0.5 parts by weight of titanium oxide were added to the spherical toner E′; (iii) 1.06 parts by weight of silica and 0.5 parts by weight of titanium oxide were added to the spherical toner G′; (iv) 1.14 parts by weight of silica and 0.6 parts by weight of titanium oxide were added to the spherical toner H′; (v) 1.21 parts by weight of silica and 0.6 parts by weight of titanium oxide were added to the spherical toner I′; (vi) 1.27 parts by weight of silica and 0.6 parts by weight of titanium oxide were added to the spherical toner J′; and (vii) 1.35 parts by weight of silica and 0.7 parts by weight of titanium oxide were added to the spherical toner K′. As a result, there were formed the spherical toner D′ having a volume mean particle size of 5.5 μm, the spherical toner E′ having a volume mean particle size of 5.9 μm, the spherical toner G′ having a volume mean particle size of 6.7 μm, the spherical toner H′ having a volume mean particle size of 7.2 μm, the spherical toner I′ having a volume mean particle size of 7.6 μm, the spherical toner J′ having a volume mean particle size of 8.0 μm, and the spherical toner K′ having a volume mean particle size of 8.5 μm.

The above-mentioned volume mean particle sizes were the values obtained from measurements on a “Multisizer II type” of Coulter Corporation. Specifically, as electrolyte, sodium chloride (first class grade chemical) was used to prepare a 1% NaCl aqueous solution. To 100 to 150 ml of this electrolyte, 0.1 to 5 ml of surface active agent as dispersing agent (preferably alkylbenzene sulfonate) was added, and 0.5 to 50 mg of a test portion toner was further added and suspended. Subsequently, this suspension was dispersed with an ultrasonic disperser for about one to three minutes. Thereafter, by using an aperture of 100 μm, the particle size distribution of toner particles was measured on the above-mentioned Multisizer II type. The volume mean particle size was determined from the volume distribution of the toner.

As the mean roundness of the toner, the mean roundness of particles having an equivalent circle diameter of not less than 2 μm was figured out with a flow type particle image analyzer (“FPIA-2100” manufactured by Sysmex Corporation).

<Evaluation Test>

The above-mentioned irregular toners A to C having the different particle sizes were combined with the spherical toners D to K, or D′ to K′, and the cleaning capability was evaluated by employing, as parameter, the ratio of the particle size of the irregular toner to the particle size of the spherical toner.

### Example 1

With the image forming apparatus of one-drum four-cycle process system as shown in FIG. 1, an image was formed by using the irregular toner and the spherical toner that were obtained in the above case for reference. As the cleaning blade 6, a urethane rubber having a hardness of 77 degrees was pressed onto the photosensitive body under linear load of 18 N/m. The roller 8 was one covered with an expanded rubber layer having a hardness of 55 degrees, and it was pressed onto an amorphous silicon photosensitive body at 1000 gf. The roller 8 made the counter rotation during cleaning, and the forward rotation when discharging the toner. The cleaning capability was evaluated by using the above-mentioned irregular toners (the irregular toners A to C) as a black toner, and the above-mentioned spherical toners (the spherical toners D to K) as color toners, in the construction of the above image forming apparatus.

The cleaning capability evaluation was made by visual observation in the following manner. That is, a solid image of 20 mm in width and 100 mm in length (the toner amount of 0.5 to 0.7 mg/cm²) was fed per color, to the cleaner with the primary transfer bias turned off. The stripe-shaped noise appearing on the image was ranked. The basis for judgment of the ranking is as follows:

Symbol “⊚” indicates no noise (the first rank);

Symbol “◯” indicates no practical problem (the second rank);

Symbol “Δ” indicates somewhat practical problem; and

Symbol “X” indicates impractical

Table 1 shows the results when only silica was used as an external additive. It will be noted from Table 1 that the second rank is secured and no practical problem occurs when the average particle size of the irregular toner is not more than 1.0 time that of the spherical toner; and that the first rank is secured particularly when the ratio of particle size is not more than 0.9.

TABLE 1
Cleaning capability ranking (External additive for spherical toner: only silica)

| | Spherical toner | | | | | | | |
|---|---|---|---|---|---|---|---|---|
| IRREGULAR toner | (Volume mean particle size/mean roundness) | | | | | | | |
| (Volume mean | Toner D | Toner E | Toner F | Toner G | Toner H | Toner I | Toner J | Toner K |
| particle size/ | (5.5 μm/ | (5.9 μm/ | (6.3 μm/ | (6.7 μm/ | (7.2 μm/ | (7.6 μm/ | (8.0 μm/ | (8.5 μm/ |
| mean roundness) | 0.97) | 0.98) | 0.97) | 0.97) | 0.97) | 0.97) | 0.97) | 0.97) |
| Toner A | X | X | ◯ | ◯ | ⊚ | ⊚ | ⊚ | ⊚ |
| (6.1 μm/0.91) | | | | | | | | |
| Toner B | X | X | X | Δ | ◯ | ⊚ | ⊚ | ⊚ |
| (6.8 μm/0.91) | | | | | | | | |
| Toner C | X | X | X | X | X | ◯ | ⊚ | ⊚ |
| (7.6 μm/0.92) | | | | | | | | |

### Example 2

The evaluation was made in the same manner as Example 1, except for the use of the spherical toner in which titanium oxide and silica were used as the external additive (the spherical toners D′ to K′). Table 2 shows the results. It will be noted from Table 2 that the addition of titanium oxide enhances the aggregating property of the spherical toner thereby to improve cleaning capability; and that when compared with the case of adding silica alone, the first rank is attainable when the ratio of the particle size of the irregular toner to the particle size of the spherical toner is not more than 1.0.

TABLE 2
Cleaning capability ranking (External additive for spherical toner: silica and titanium oxide)

| | Spherical toner | | | | | | | |
|---|---|---|---|---|---|---|---|---|
| Irregular toner | (Volume mean particle size/mean roundness) | | | | | | | |
| (Volume mean | Toner D′ | Toner E′ | Toner F′ | Toner G′ | Toner H′ | Toner I′ | Toner J′ | Toner K′ |
| particle size/ | (5.5 μm/ | (5.9 μm/ | (6.3 μm/ | (6.7 μm/ | (7.2 μm/ | (7.6 μm/ | (8.0 μm | (8.5 μm/ |
| mean roundness) | 0.97) | 0.98) | 0.97) | 0.97) | 0.97) | 0.97) | /0.97) | 0.97) |
| Toner A | X | Δ | ⊚ | ⊚ | ⊚ | ⊚ | ⊚ | ⊚ |
| (6.1 μm/0.91) | | | | | | | | |
| Toner B | X | X | X | Δ | ⊚ | ⊚ | ⊚ | ⊚ |
| (6.8 μm/0.91) | | | | | | | | |
| Toner C | X | X | X | X | Δ | ⊚ | ⊚ | ⊚ |
| (7.6 μm/0.92) | | | | | | | | |

The foregoing test results show that no image noise occurs when the volume mean particle size of the irregular toner is not more than the volume mean particle size of the spherical toner.

It is further understood by those skilled in the art that the foregoing description is a preferred embodiment of the disclosed image forming apparatus and image forming method and that various changes and modifications may be made in the invention without departing from the spirit and scope thereof.

What is claimed is:

1. An image forming apparatus for forming a color image with a plurality of color toners, comprising:
a photosensitive body;
a rotary developing device for developing a latent image on the photosensitive body by selectively allowing developing units corresponding to their respective color toners to rotationally move to a developing position opposite the photosensitive body; and
a cleaning blade for removing residual toner on the photosensitive body,
wherein,
at least one color toner in the plurality of color toners is an irregular toner, and other color toners are spherical toners, and
a volume mean particle size of the irregular toner is not more than a volume mean particle size of the spherical toner.

2. The image forming apparatus according to claim 1, wherein the irregular toner is a black toner, and the spherical toner is a color toner other than black.

3. The image forming apparatus according to claim 1, wherein the irregular toner and the spherical toner contain silica as an external additive.

4. The image forming apparatus according to claim 3, further containing titanium oxide as the external additive.

5. The image forming apparatus according to claim 1, wherein the volume mean particle size of the irregular toner satisfies the following equation (I):
A<0.9×B (I)
where A is a volume mean particle size of the irregular toner, and B is a volume mean particle size of the spherical toner.

6. The image forming apparatus according to claim 1, wherein the spherical toner has a mean roundness of not less than 0.97.

7. The image forming apparatus according to claim 1, wherein the irregular toner is a toner obtained by grinding classification method, and the spherical toner is a toner obtained by polymerization method.

8. The image forming apparatus according to claim 1, wherein a roller and the cleaning blade are disposed in this order in a direction of movement of the photosensitive body, and the roller makes a counter rotation with respect to the photosensitive body during cleaning, and the roller makes a forward rotation after cleaning.

9. A method for forming an image, comprising:
the step of forming a color image with a plurality of color toners by developing a latent image on a photosensitive body by selectively allowing developing units corresponding to their respective color toners to rotationally move to a developing position opposite the photosensitive body; and
a cleaning step for removing a residual toner on the photosensitive body by using a cleaning blade,
wherein,
at least one color toner in the plurality of color toners is an irregular toner, and other color toners are spherical toners, and
a volume mean particle size of the irregular toner is not more than a volume mean particle size of the spherical toner.
